(19) United States
(12) Patent Application Publication
(10) Pub. No.: US 2024/0122686 A1
(43) Pub. Date: Apr. 18, 2024

(54) DENTAL SCREW FOR OSSEOINTEGRATION OF BONE SURFACE

(71) Applicant: E- WIRELIGNER CO., LTD., Jeollabuk-do (KR)

(72) Inventor: Youn Sic Chun, Seoul (KR)

(73) Assignee: E- WIRELIGNER CO., LTD., Jeollabuk-do (KR)

(21) Appl. No.: 18/225,263

(22) Filed: Jul. 24, 2023

(30) Foreign Application Priority Data
Oct. 12, 2022 (KR) 10-2022-0130548

(51) Int. Cl. A61C 8/00

(52) U.S. Cl. CPC A61C 8/0096; A61C 8/008

(57) ABSTRACT

A dental screw for osseointegration of a bone surface includes a base, a healing cap, and a handle. The base includes a penetrating body configured to penetrate into a bone. An area of the penetrating body at a proximal side of the base is smaller than an area of the penetrating body at a distal side of the base.

### CROSS-REFERENCE TO RELATED APPLICATION

This application claims the benefit of Korean Patent Application No. 10-2022-0130548 filed on Oct. 12, 2022, in the Korean Intellectual Property Office, the entire disclosure of which is incorporated herein by reference for all purposes.

### BACKGROUND

### 1. Field of the Invention

The disclosure generally relates to a dental screw, and for example, to a dental screw configured to be bonded to a bone surface by osseointegration.

### 2. Description of the Related Art

An orthodontic anchoring device, which is used by being fixed to a bone within oral tissue, is being developed. This anchoring device remains fixed to the bone for a long period of time, approximately two months, until it is integrated with the bone. Therefore, adhesion between the anchoring device and the bone may be crucial to ensure that the anchoring device remains securely fixed to the bone for a long period of time while preventing contamination of the oral tissue from the outside. For example, Korean Patent Application Publication KR 10-2020-0112499 A discloses an orthodontic anchoring device and system. The above description is information acquired during the course of conceiving the present disclosure, or already possessed at the time, and is not necessarily art publicly known before the present application was filed.

### SUMMARY

An aspect of the disclosure may provide a dental screw that is stably maintained on a bone surface. An aspect of the disclosure may provide a dental screw that increases the probability of osseointegration with a bone surface.

According to an embodiment, a dental screw may be a dental screw for osseointegration of a bone surface. The dental screw may include a base including a first base surface, a second base surface opposite to the first base surface, a side base surface between the first base surface and the second base surface, a hole disposed on the first base surface, and a first engaging portion formed in the hole, a healing cap including a first cap surface, a second cap surface opposite to the first cap surface and facing at least a portion of the hole, a side cap surface positioned between the first cap surface and the second cap surface and facing at least a portion of the hole, a second engaging portion formed on the side cap surface and configured to engage with the first engaging portion, and a recess disposed on the first cap surface, and a handle configured to couple the healing cap to the base, wherein the base may further include a plurality of penetrating bodies arranged along an edge of the second base surface, the plurality of penetrating bodies may include a first piercing surface connected to the second base surface, a second piercing surface spaced apart from the second base surface, and a plurality of side piercing surfaces between the first piercing surface and the second piercing surface, the first piercing surface may have a first area, and the second piercing surface may have a second area greater than the first area.

In an embodiment, the plurality of side piercing surfaces may include an outer side piercing surface, an inner side piercing surface opposite to the outer side piercing surface, and a plurality of circumferential side piercing surfaces between the outer side piercing surface and the inner side piercing surface.

In an embodiment, the plurality of side piercing surfaces may have widths that increase from the first piercing surface toward the second piercing surface.

In an embodiment, the second piercing surface may be inclined with respect to the first piercing surface.

In an embodiment, the plurality of side piercing surfaces may be curved.

In an embodiment, the base may further include a depression formed inside an edge of the second base surface.

In an embodiment, the first engaging portion and the second engaging portion may each have a screw thread.

In an embodiment, the handle may include a protrusion configured to engage with the recess.

In an embodiment, the handle may include a first shaft end surface, a second shaft end surface opposite to the first shaft end surface, a side shaft surface between the first shaft end surface and the second shaft end surface, and a third engaging portion formed on the side shaft end and configured to engage with the first engaging portion.

According to an embodiment, a dental screw may be a dental screw for osseointegration of a bone surface. The dental screw may include a base including a first base surface, a second base surface opposite to the first base surface, a side base surface between the first base surface and the second base surface, a hole disposed on the first base surface, and a first engaging portion formed in the hole, a handle comprising a first shaft end surface, a second shaft end surface opposite to the first shaft end surface, a side shaft end surface between the first shaft end surface and the second shaft end surface, and a second engaging portion formed on the side shaft end surface and configured to engage with the first engaging portion, wherein the base may further include a plurality of penetrating bodies arranged along an edge of the second base surface, the plurality of penetrating bodies may include a first piercing surface connected to the second base surface, a second piercing surface spaced apart from the second base surface, and a plurality of side piercing surfaces between the first piercing surface and the second piercing surface, the first piercing surface may have a first area, and the second piercing surface may have a second area greater than the first area.

In an embodiment, the plurality of side piercing surfaces may include an outer side piercing surface, an inner side piercing surface opposite to the outer side piercing surface, and a plurality of circumferential side piercing surfaces between the outer side piercing surface and the inner side piercing surface.

In an embodiment, the plurality of side piercing surfaces may have widths that increase from the first piercing surface toward the second piercing surface.

In an embodiment, the second piercing surface may be inclined with respect to the first piercing surface.

In an embodiment, the plurality of side piercing surfaces may be curved.

In an embodiment, the base may further include a depression formed inside an edge of the second base surface.

Additional aspects of example embodiments will be set forth in part in the description which follows and, in part, will be apparent from the description, or may be learned by practice of the disclosure.

According to an embodiment, a dental screw may be stably maintained on a bone surface. According to an embodiment, the dental screw may increase the probability of osseointegration with a bone surface. The effects of the dental screw are not limited to the above-mentioned effects, and other unmentioned effects can be clearly understood from the following description by one of ordinary skill in the art to which the present disclosure pertains.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an orthodontic appliance according to an embodiment;

FIG. 2 is a perspective view of a dental screw according to an embodiment;

FIG. 3 is an exploded perspective view of a dental screw according to an embodiment;

FIG. 4 is a perspective view of a base according to an embodiment;

FIG. 5 is a plan view of a base according to an embodiment;

FIG. 6 is a bottom view of a base according to an embodiment;

FIG. 7 is a cross-sectional view of the base of FIG. 6, taken along a line 7-7 according to an embodiment;

FIG. 8 is a perspective view of a healing cap according to an embodiment;

FIG. 9 is a plan view of a healing cap according to an embodiment;

FIG. 10 is a cross-sectional view of the healing cap of FIG. 9, taken along a line 10-10 according to an embodiment;

FIG. 11 is a perspective view of a handle viewed in one direction according to an embodiment;

FIG. 12 is a perspective view of a handle viewed in another direction according to an embodiment;

FIG. 13 is a perspective view of a dental screw according to an embodiment;

FIG. 14 is an exploded perspective view of a dental screw according to an embodiment;

FIG. 15 is a plan view of a handle according to an embodiment; and

FIG. 16 is a plan view of the handle of FIG. 15, taken along a line 16-16 according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting to the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or combinations thereof but do not preclude the presence or addition of one or more other features, integers, steps, operations, elements, components and/or combinations thereof.

Unless otherwise defined, all terms including technical and scientific terms used herein have the same meaning as commonly understood by one of ordinary skill in the art to which embodiments belong. Terms, such as those defined in commonly used dictionaries, are to be interpreted as having a meaning consistent with their meaning in the context of the relevant art and the present disclosure and are not to be interpreted in an idealized or overly formal sense unless expressly so defined herein.

When describing the embodiments with reference to the accompanying drawings, like reference numerals refer to like components and a repeated description related thereto will be omitted. When describing the embodiments, a detailed description of well-known related technologies will be omitted when it is deemed that such a description will cause an ambiguous interpretation of the present disclosure.

In addition, terms such as first, second, A, B, (a), (b), and the like may be used to describe components of the embodiments. These terms are used only for the purpose of distinguishing one component from another component, and the nature, sequences, or orders of the components are not limited by the terms. It is to be understood that if a component is described as being “connected,” “coupled” or “joined” to another component, the former may be directly “connected,” “coupled,” and “joined” to the latter or “connected”, “coupled”, and “joined” to the latter via another component.

Components included in an embodiment and components having a common function are described using the same names in other embodiments. Unless stated otherwise, the description of an embodiment may be applicable to other embodiments, and a repeated description related thereto is omitted.

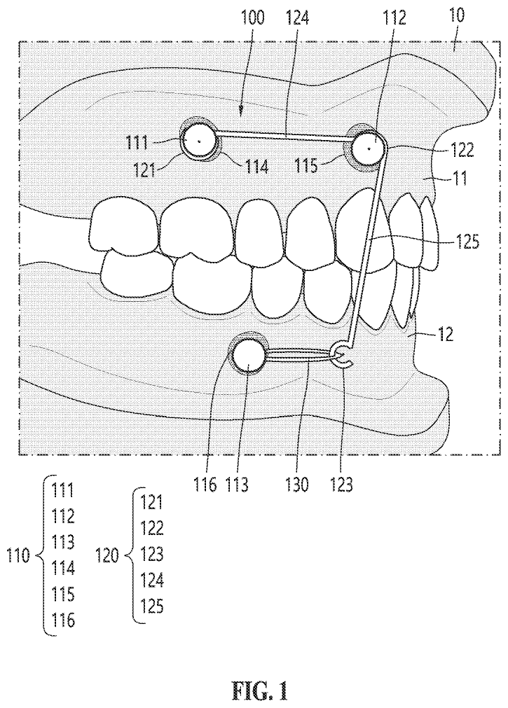

FIG. 1 illustrates an orthodontic appliance according to an embodiment.

Referring to FIG. 1, an orthodontic appliance 100 may be configured to treat or correct the sleep apnea of a subject 10. In an oral structure to which the orthodontic appliance 100 is applied, the impact provided to a surrounding tooth or teeth may be reduced. When applied to the subject 10, the orthodontic appliance 100 may reduce or eliminate a sense of discomfort that a user may feel. Once applied to the subject 10, the orthodontic appliance 100 may be used semi-permanently.

In an embodiment, the orthodontic appliance 100 may include a fixed portion 110 configured to be fixed to the subject 10. The fixed portion 110 may include a first dental screw 111 configured to be fixed to a first portion of a first jawbone 11 (e.g., a maxilla) of the subject 10. The fixed portion 110 may include a second dental screw 112 configured to be fixed to a second portion of the first jawbone 11, the second portion being different from the first portion of the first jawbone 11 of the subject 10. The fixed portion 110 may include a third dental screw 113 configured to be fixed to a second jawbone 12 (e.g., a mandible) of the subject 10. The first portion and the second portion of the first jawbone 11 may be spaced apart from each other in an arrangement direction of teeth disposed on the first jawbone 11.

In an embodiment, the orthodontic appliance 100 may include a first bonding portion 114 configured to bond the first dental screw 111 and the first portion (e.g., a tissue surface) of the first jawbone 11. The orthodontic appliance 100 may include a second bonding portion 115 configured to bond the second dental screw 112 and the second portion (e.g., a tissue surface) of the first jawbone 11. The orthodontic appliance 100 may include a third bonding portion 116 configured to bond the third dental screw 113 and a portion (e.g., a tissue surface) of the second jawbone 12.

In an embodiment, the orthodontic appliance 100 may include a connecting portion 120 configured to connect a plurality of dental screws 111, 112, and 113. The connecting portion 120 may include a first hoop 121 configured to engage with the first dental screw 111. The first hoop 121 may be disposed on the first jawbone 11. The connecting portion 120 may include a second hoop 122 configured to engage with the second dental screw 112. The second hoop 122 may be disposed on the first jawbone 11. The connecting portion 120 may include a third hoop 123. The third hoop 123 may be disposed on the second jawbone 12. The connecting portion 120 may include a first bar 124 connected to the first hoop 121 and the second hoop 122. The connecting portion 120 may include a second bar 125 connected to the second hoop 122 and the third hoop 123.

In an embodiment, the orthodontic appliance 100 may include a traction portion 130 configured to exert traction on the second jawbone 12. The traction portion 130 may be configured to exert traction on the third hoop 123 toward the third dental screw 113. The traction portion 130 may elastically deform. The traction portion 130 may form a closed loop.

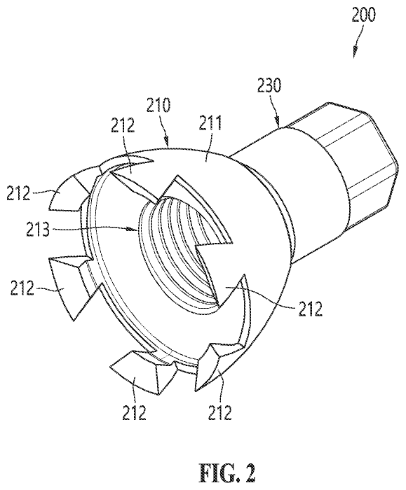

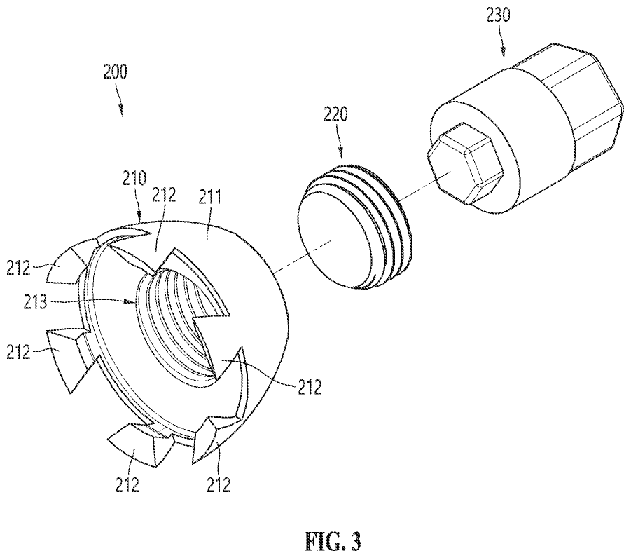

FIG. 2 is a perspective view of a dental screw according to an embodiment. FIG. 3 is an exploded perspective view of a dental screw according to an embodiment.

Referring to FIGS. 2 and 3, a dental screw 200 (e.g., the first dental screw 111, the second dental screw 112, and/or the third dental screw 113 of FIG. 1) may include a base 210. The base 210 may include a base body 211. The base body 211 may be disposed on or above a surface of an oral structure (e.g., the first jawbone 11 and/or the second jawbone 12 of FIG. 1) of a subject (e.g., the subject 10 of FIG. 1).

In an embodiment, the base 210 may include a plurality (e.g., six) of penetrating bodies 212. The plurality of penetrating bodies 212 may be configured to penetrate into the oral structure (e.g., the first jawbone 11 and/or the second jawbone 12) of the subject (e.g., the subject of FIG. 1). A biological substance (e.g., blood) generated from the oral structure when the plurality of penetrating bodies 212 penetrates into the oral structure may flow between the oral structure and the base body 211. The base body 211 may be bonded (e.g., adhered) to a surface of the oral structure by the biological substance.

In an embodiment, the plurality of penetrating bodies 212 may be configured to be fixed in the oral structure (e.g., the first jawbone 11 and/or the second jawbone 12) of the subject (e.g., the subject 10 of FIG. 1). When the plurality of penetrating bodies 212 is inserted into the oral structure, the plurality of penetrating bodies 212 may be configured to prevent easy removal from the oral structure. The base body 211 may be stably maintained on or above the surface of the oral structure.

In an embodiment, the dental screw 200 may include a healing cap 220. The healing cap 220 may be configured to aid in the healing of soft tissue and/or hard tissue around the base 210. The healing cap 220 may be configured to protect the base 210 from a biological substance (e.g., debris accumulation such as plaque) around the base 210. The healing cap 220 may be configured to be coupled to the base 210. For example, the healing cap 220 may be screwed to the base 210.

In an embodiment, the dental screw 200 may include a handle 230. The handle 230 may be configured to couple the healing cap 220 to the base 210 by an external input (e.g., force by a user). The handle 230 may be configured to be coupled to and fit onto the healing cap 220. As the handle 230 and the healing cap 220 are coupled, a force applied to the handle 230 may be transferred to the healing cap 220.

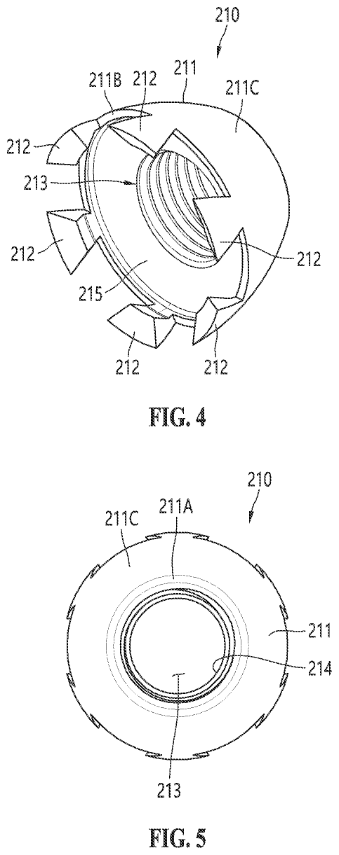

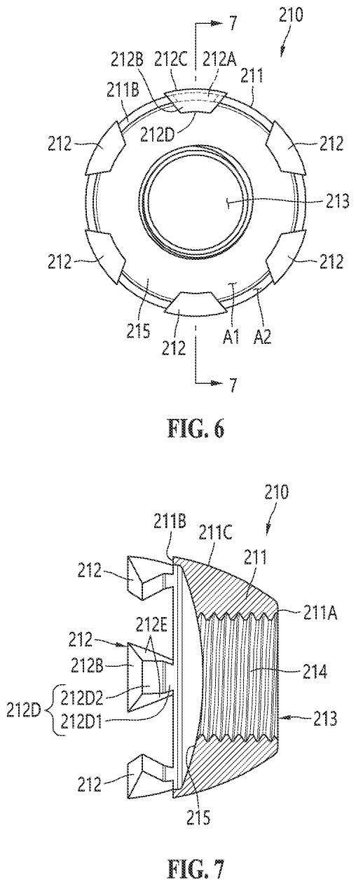

FIG. 4 is a perspective view of a base according to an embodiment. FIG. 5 is a plan view of a base according to an embodiment. FIG. 6 is a bottom view of a base according to an embodiment. FIG. 7 is a cross-sectional view of the base of FIG. 6, taken along a line 7-7 according to an embodiment.

Referring to FIGS. 4 to 7, the base 210 may include the base body 211. The base body 211 may include a first base surface 211A (e.g., a front base surface), a second base surface 211B (e.g., a rear base surface) opposite to the first base surface 211A, and a side base surface 211C between the first base surface 211A and the second base surface 211B.

In an embodiment, a diameter or width of the first base surface 211A may be greater than a diameter or width of the second base surface 211B. In an embodiment not shown, the diameter or width of the first base surface 211A may be substantially the same as the diameter or width of the second base surface 211B. In an embodiment not shown, the diameter or width of the first base surface 211A may be smaller than the diameter or width of the second base surface 211B.

In an embodiment, the side base surface 211C may include a curved surface. For example, the side base surface 211C may include a convex surface. In an embodiment not shown, the side base surface 211C may include a surface (e.g., a flat surface) having a substantially linear profile.

In an embodiment, the base 210 may include the plurality of penetrating bodies 212. The plurality of penetrating bodies 212 may include a first piercing surface 212A (e.g., a front piercing surface), a second piercing surface 212B (e.g., a rear piercing surface) opposite to the first piercing surface 212A, an outer side piercing surface 212C between the first piercing surface 212A and the second piercing surface 212B, an inner side piercing surface 212D opposite to the outer side piercing surface 212C and between the first piercing surface 212A and the second piercing surface 212B, and a plurality (e.g., two) of circumferential side piercing surfaces 212E between the first piercing surface 212A and the second piercing surface 212B and between the outer side piercing surface 212C and the inner side piercing surface 212D.

In an embodiment, the first piercing surface 212A may be connected to the second base surface 211B. The first piercing surface 212A may be on substantially the same plane as the second base surface 211B. The first piercing surface 212A and the second base surface 211B may be integrally and seamlessly connected.

In an embodiment, the second piercing surface 212B may be spaced apart from the second base surface 211B. In an embodiment, the second piercing surface 212B may be inclined at a substantially determined non-zero angle with respect to the first piercing surface 212A. In an embodiment, the second piercing surface 212B may be substantially parallel to the first piercing surface 211A. In an embodiment, the second piercing surface 212B may include a surface (e.g., a flat surface) having a substantially linear profile.

In an embodiment, an area of the second piercing surface 212B may be greater than an area of the first piercing surface 212A. This may prevent the plurality of penetrating bodies 212 from easily being removed by an external force when the plurality of penetrating bodies 212 penetrates into and is inserted into oral tissue (e.g., the first jawbone 11 and/or the second jawbone 12 of FIG. 1) of a subject (e.g., the subject 10 of FIG. 1). Accordingly, the base body 211 may be stably maintained on a surface of the oral tissue.

In an embodiment, the outer side piercing surface 212C may be connected to the side base surface 211C. In an embodiment, the outer side piercing surface 212C and the side base surface 211C may be integrally and seamlessly connected. In an embodiment, the outer side piercing surface 212C may include a curved surface.

In an embodiment, the inner side piercing surface 212D may be connected to the second base surface 211B. In an embodiment, the inner side piercing surface 212D and the second base surface 211B may be integrally and seamlessly connected.

In an embodiment, the inner side piercing surface 212D may include a first inner side piercing surface 212D1. The first inner side piercing surface 212D1 may form a first determined non-zero angle (e.g., 90 degrees) with the second base surface 211B. The first inner side piercing surface 212D1 may be connected to the second base surface 211B.

In an embodiment, the inner side piercing surface 212D may include a second inner side piercing surface 212D2. The second inner side piercing surface 212D2 may be inclined at a second determined non-zero angle (e.g., 120 degrees) with respect to the first inner side piercing surface 212D1. The second inner side piercing surface 212D2 may be connected to the first inner side piercing surface 212D1 and the second piercing surface 212B.

In an embodiment, the plurality of circumferential side piercing surfaces 212E may have widths that vary between the first piercing surface 212A and the second piercing surface 212B. For example, the plurality of circumferential side piercing surfaces 212E may have widths that increase in a direction from the first piercing surface 212A toward the second piercing surface 212B. For example, the plurality of circumferential side piercing surfaces 212E may have widths that increase at a first gradient in a region connected to the first inner side piercing surface 212D1 and have widths that increase at a second gradient in a region connected to the second inner side piercing surface 212D2.

In an embodiment, the plurality of penetrating bodies 212 may be disposed on the second base surface 211B. For example, the plurality of penetrating bodies 212 may be arranged in a circumferential direction of the second base surface 211B along an edge of the second base surface 211B.

In an embodiment, the plurality of penetrating bodies 212 may be spaced apart from each other. A distance between a pair of adjacent penetrating bodies 212 may be substantially the same as a distance between another pair of adjacent penetrating bodies 212.

In an embodiment, the base 210 may include a hole 213. The hole 213 may include a substantially cylindrical shape. The hole 213 may pass through the base 210 from the first base surface 211A to the second base surface 211B. In addition to an anchoring force of the penetrating bodies 212, the hole 213 may improve an anchoring force of the healing cap 220 and/or the handle 230.

In an embodiment, the base 210 may include a first engaging portion 214. The first engaging portion 214 may be disposed on a side surface of the hole 213. For example, the first engaging portion 214 may include a screw thread.

In an embodiment, the base 210 may include a depression 215. The depression 215 may be disposed on the second base surface 211B in a direction toward the first base surface 211A.

In an embodiment, the depression 215 may include a substantially curved surface.

In an embodiment, the depression 215 may form an edge region A2 different from a central region A1. The plurality of penetrating bodies 212 may be disposed in the edge region A2. The plurality of penetrating bodies 212 may not be disposed in the central region A1.

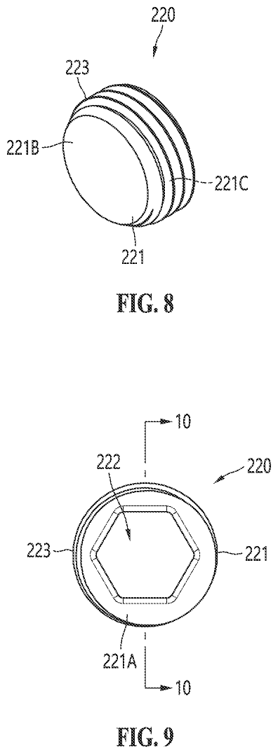

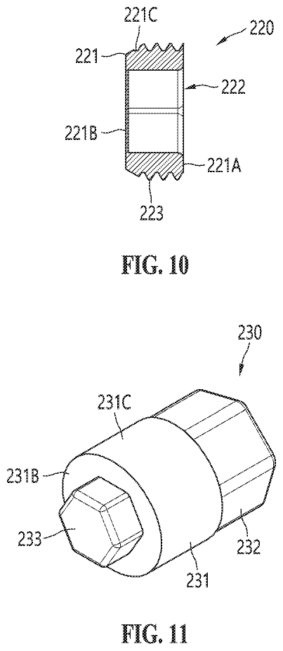

FIG. 8 is a perspective view of a healing cap according to an embodiment. FIG. 9 is a plan view of a healing cap according to an embodiment. FIG. 10 is a cross-sectional view of the healing cap of FIG. 9, taken along a line 10-10 according to an embodiment.

Referring to FIGS. 8 to 10, the healing cap 220 may include a cap body 221. The cap body 221 may include a first cap surface 221A (e.g., a front cap surface), a second cap surface 221B (e.g., a rear cap surface) opposite to the first cap surface 221A, and a side cap surface 221C between the first cap surface 221A and the second cap surface 221B. According to an embodiment, when the healing cap 220 is coupled to a base (e.g., the base 210 of FIGS. 4 to 7), the second cap surface 221B may at least partially face a bottom surface of a hole (e.g., the hole 213 of FIGS. 4 to 7) of the base, and the side cap surface 221C may at least partially face a side surface of the hole of the base.

In an embodiment, the cap body 221 may include a substantially cylindrical shape.

In an embodiment, the healing cap 220 may include a recess 222. The recess 222 may include a polygonal shape. For example, the recess 222 may include a hexagonal shape. In an example not shown, the recess 222 may include a substantially circular or elliptical shape. The recess 222 may be formed on the first cap surface 221A toward the second cap surface 221B.

In an embodiment, the healing cap 220 may include a second engaging portion 223. The second engaging portion 223 may be configured to engage with the first engaging portion 214 of the base (e.g., the base 210 of FIGS. 4 to 7). The second engaging portion 223 may be disposed on the side cap surface 221C. The second engaging portion 223 may extend between the first cap surface 221A and the second cap surface 221B along a portion of the side cap surface 221C or a substantially entirety of the side cap surface 221C. For example, the second engaging portion 223 may include a screw thread.

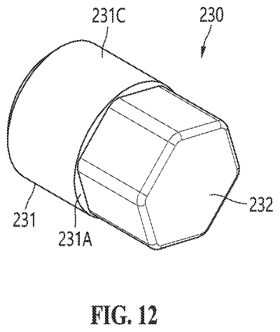

FIG. 11 is a perspective view of a handle viewed in one direction according to an embodiment. FIG. 12 is a perspective view of a handle viewed in another direction according to an embodiment.

Referring to FIGS. 11 and 12, the handle 230 may include a shaft 231. The shaft 231 may include a first shaft end surface 231A, a second shaft end surface 231B opposite to the first shaft end surface 231A, and a side shaft surface 231C between the first shaft end surface 231A and the second shaft end surface 231B. The second shaft end surface 231B may face a bottom surface of a recess (e.g., the recess 222 of FIGS. 8 to 10) of a healing cap (e.g., the healing cap 220 of FIGS. 8 to 10).

In an embodiment, the shaft 231 may include a substantially cylindrical shape.

In an embodiment, the handle 230 may include a first protrusion 232. The protrusion 232 may protrude from the first shaft end surface 231A.

In an embodiment, a protrusion length of the first protrusion 232 may be substantially the same as a length of the shaft 231. In an embodiment not shown, the protrusion length of the first protrusion 232 may be greater than the length of the shaft 231. In an embodiment not shown, the protrusion length of the first protrusion 232 may be smaller than the length of the shaft 231.

In an embodiment, a diameter or width of the first protrusion 232 may be smaller than a diameter or width of the shaft 231. In an embodiment not shown, the diameter or width of the first protrusion 232 may be substantially the same as the diameter or width of the shaft 231. In an embodiment not shown, the diameter or width of the first protrusion 232 may be greater than the diameter or width of the shaft 231.

In an embodiment, the handle 230 may include a second protrusion 233. The second protrusion 233 may protrude from the second shaft end surface 231B. The second protrusion 233 may be configured to engage with the recess (e.g., the recess 222 of FIGS. 8 to 10) of the healing cap (e.g., the healing cap 220 of FIGS. 8 to 10). For example, the second protrusion 233 may include a polygonal shape (e.g., a hexagonal shape). In an embodiment not shown, the second protrusion 233 may include a substantially circular or elliptical shape.

In an embodiment, a protrusion length of the second protrusion 233 may be smaller than the protrusion length of the first protrusion 232. In an embodiment not shown, the protrusion length of the second protrusion 233 may be substantially the same as the protrusion length of the first protrusion 232. In an embodiment not shown, the protrusion length of the second protrusion 233 may be greater than the protrusion length of the first protrusion 232.

In an embodiment, a diameter or width of the second protrusion 233 may be smaller than the diameter or width of the shaft 231. In an embodiment not shown, the diameter or width of the second protrusion 233 may be substantially the same as the diameter or width of the shaft 231. In an embodiment not shown, the diameter or width of the second protrusion 233 may be greater than the diameter or width of the shaft 231.

In an embodiment, the diameter or width of the second protrusion 233 may be smaller than the diameter or width of the first protrusion 232. In an embodiment not shown, the diameter or width of the second protrusion 233 may be substantially the same as the diameter or width of the first protrusion 232. In an embodiment not shown, the diameter or width of the second protrusion 233 may be smaller than the diameter or width of the first protrusion 232.

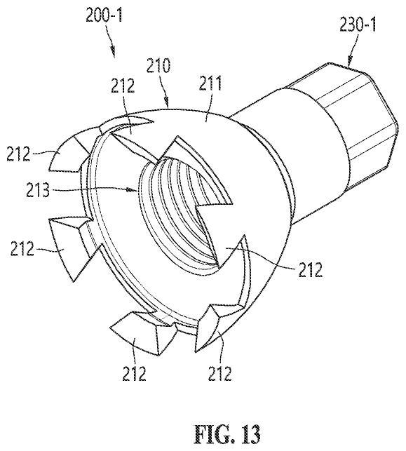

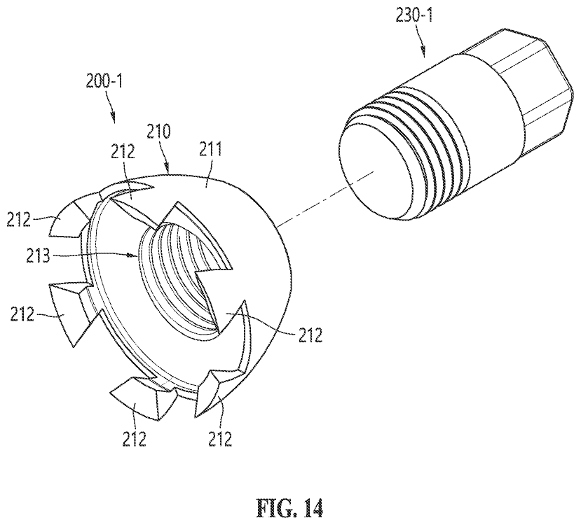

FIG. 13 is a perspective view of a dental screw according to an embodiment. FIG. 14 is an exploded perspective view of a dental screw according to an embodiment.

Referring to FIGS. 13 and 14, a dental screw 200-1 (e.g., the first dental screw 111, the second dental screw 112, and/or the third dental screw 113 of FIG. 1 and/or the dental screw 200 of FIGS. 2 and 3) may include the base 210 and a handle 230-1 (e.g., the handle 230 of FIGS. 2, 3, 11, and 12). The handle 230-1 may be configured to be coupled to the base 210. The base 210 may include the base body 211 and the plurality of penetrating bodies 212.

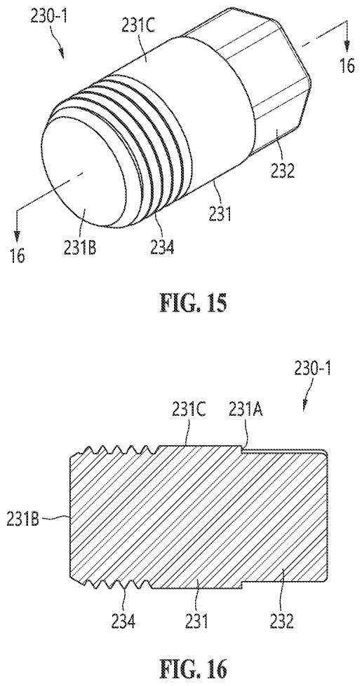

FIG. 15 is a plan view of a handle according to an embodiment. FIG. 16 is a plan view of the handle of FIG. 15, taken along a line 16-16 according to an embodiment.

Referring to FIGS. 15 and 16, the handle 230-1 (e.g., the handle 230 of FIGS. 2, 3, 11, and 12) may include the shaft 231 and the first protrusion 232.

In an embodiment, the handle 230-1 may include a third engaging portion 234. The third engaging portion 234 may be configured to engage with a first engaging portion (e.g., the first engaging portion 214 of FIGS. 4 to 7) of a base (e.g., the base 210 of FIGS. 4 to 7). In an embodiment, the third engaging portion 234 may include a screw thread.

In an embodiment, the third engaging portion 234 may be disposed on the side shaft surface 231C. The third engaging portion 234 may be formed between the first shaft end surface 231A and the second shaft end surface 231B along a portion of the side shaft surface 231C. The third engaging portion 234 may be partially formed on the side shaft surface 231C from the second shaft end surface 231B toward the first shaft end surface 231A. In an embodiment not shown, the third engaging portion 234 may be formed between the first shaft end surface 231A and the second shaft end surface 231B along a substantially entirety of the side shaft surface 231C.

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner or replaced or supplemented by other components or their equivalents.

Therefore, other implementations, other embodiments, and equivalents of the claims are within the scope of the following claims.

The features and aspects of any embodiment(s) described above may be combined with features and aspects of any other embodiment(s) without resulting in apparent technical conflicts.

What is claimed is:

1. A dental screw for osseointegration of a bone surface, the dental screw comprising:
a base;
a healing cap; and
a handle configured to couple the healing cap to the base,
wherein the base comprises:
a first base surface;
a second base surface opposite to the first base surface;
a side base surface between the first base surface and the second base surface;
a hole disposed on the first base surface; and
a first engaging portion formed in the hole,
wherein the healing cap comprises:
a first cap surface;
a second cap surface opposite to the first cap surface and facing at least a portion of the hole;
a side cap surface positioned between the first cap surface and the second cap surface and facing at least a portion of the hole;
a second engaging portion formed on the side cap surface and configured to engage with the first engaging portion; and
a recess disposed on the first cap surface,
wherein the base further comprises a plurality of penetrating bodies arranged along an edge of the second base surface,
wherein the plurality of penetrating bodies comprises:
a first piercing surface connected to the second base surface;
a second piercing surface spaced apart from the second base surface; and
a plurality of side piercing surfaces between the first piercing surface and the second piercing surface, and
wherein the first piercing surface has a first area, and the second piercing surface has a second area greater than the first area.

2. The dental screw of claim 1, wherein the plurality of side piercing surfaces comprises:
an outer side piercing surface;
an inner side piercing surface opposite to the outer side piercing surface; and
a plurality of circumferential side piercing surfaces between the outer side piercing surface and the inner side piercing surface.

3. The dental screw of claim 1, wherein the plurality of side piercing surfaces has widths that increase from the first piercing surface toward the second piercing surface.

4. The dental screw of claim 1, wherein the second piercing surface is inclined with respect to the first piercing surface.

5. The dental screw of claim 1, wherein the plurality of side piercing surfaces is curved.

6. The dental screw of claim 1, wherein the base further comprises a depression formed inside an edge of the second base surface.

7. The dental screw of claim 1, wherein the first engaging portion and the second engaging portion each comprise a screw thread.

8. The dental screw of claim 1, wherein the handle comprises a protrusion configured to engage with the recess.

9. The dental screw of claim 1, wherein the handle comprises:
a shaft comprising a first shaft end surface, a second shaft end surface opposite to the first shaft end surface, and a side shaft surface between the first shaft end surface and the second shaft end surface; and
a third engaging portion formed on the side shaft surface and configured to engage with the first engaging portion.

10. A dental screw for osseointegration of a bone surface, the dental screw comprising:
a base; and
a handle,
wherein the base comprises:
a first base surface;
a second base surface opposite to the first base surface;
a side base surface between the first base surface and the second base surface;
a hole disposed on the first base surface; and
a first engaging portion formed in the hole,
wherein the handle comprises:
a first shaft end surface;
a second shaft end surface opposite to the first shaft end surface;
a side shaft end surface between the first shaft end surface and the second shaft end surface; and
a second engaging portion formed on the side shaft end surface and configured to engage with the first engaging portion,
wherein the base further comprises a plurality of penetrating bodies arranged along an edge of the second base surface,
wherein the plurality of penetrating bodies comprises:
a first piercing surface connected to the second base surface;
a second piercing surface spaced apart from the second base surface; and
a plurality of side piercing surfaces between the first piercing surface and the second piercing surface, and
wherein the first piercing surface has a first area, and the second piercing surface has a second area greater than the first area.

11. The dental screw of claim 10, wherein the plurality of side piercing surfaces comprises:
an outer side piercing surface;
an inner side piercing surface opposite to the outer side piercing surface; and
a plurality of circumferential side piercing surfaces between the outer side piercing surface and the inner side piercing surface.

12. The dental screw of claim 10, wherein the plurality of side piercing surfaces has widths that increase from the first piercing surface toward the second piercing surface.

13. The dental screw of claim 10, wherein the second piercing surface is inclined with respect to the first piercing surface.

14. The dental screw of claim 10, wherein the plurality of side piercing surfaces is curved.

15. The dental screw of claim 10, wherein the base further comprises a depression formed inside an edge of the second base surface.
